(19) United States
(12) Patent Application Publication
(10) Pub. No.: US 2024/0303942 A1
(43) Pub. Date: Sep. 12, 2024

(54) Asynchronous Shared Virtual Experiences

(71) Applicant: Niantic, Inc., San Francisco, CA (US)

(72) Inventors: Ryuta Hiroi, San Francisco, CA (US); Masashi Kawashima, Palo Alto, CA (US); Michael Joseph Garcia Bader, San Francisco, CA (US); Alejandro Aguilar, Salinas, CA (US); Leif Wilden, San Mateo, CA (US)

(21) Appl. No.: 18/597,233

(22) Filed: Mar. 6, 2024

Related U.S. Application Data
(60) Provisional application No. 63/450,369, filed on Mar. 6, 2023.

(51) Int. Cl. G06T 19/00; G06T 19/20

(52) U.S. Cl. CPC G06T 19/006; G06T 19/20; G06T 2219/2004

(57) ABSTRACT

The present disclosure describes a location-based application in which users can attach media content to geographic locations. Other users can later experience the media content when in proximity to the geographic content or via a map interface displaying indications of media content in the vicinity of the viewing user. When users experience media content attached to a geographic location they may initiate communication with the creator of the media content. Additionally, the creator or viewer of a video or photograph of a geographic location may select an object depicted in the video or photograph to create a 2D or 3D virtual object representing the depicted object. This virtual object may be held by the user (e.g., in a virtual bag) or dropped at the same or a different geographic location where it may be viewed and interacted with by other users in an augmented reality environment.

### CROSS-REFERENCE TO RELATED APPLICATIONS

This application claims the benefit of U.S. Provisional Patent Application No. 63/450,369, filed Mar. 6, 2023, which is incorporated by reference.

### BACKGROUND

### 1. Technical Field

The subject matter described relates generally to location-based applications, and, in particular, to an application that asynchronously provides shared virtual experiences at geographic locations.

### 2. Problem

Existing review and recommendation systems allow users to submit information about locations they have visited. However, the submitted information can seem disconnected from actual experiences at those locations, making other users distrustful of their accuracy and value, particularly when the timing of the submitted information is unknown or long before another user is viewing it. Furthermore, users may lack means to ask questions to receive clarification about existing information or solicit additional information. Overall, such systems are inefficient in providing users with a sense of what a location is really like and fail to provide dynamic, interactive experiences.

### SUMMARY

The present disclosure describes a location-based application in which users can attach media content to geographic locations. Other users can later experience the media content when in proximity to the geographic content. When users experience media content attached to a geographic location they may initiate communication with the creator of the media content, referred to as a “wave.” This communication may be provided within the location-based application to users that would otherwise have no means to communicate with each other and may take various forms, such as default messages selected from a set of available messages, video messages, free-text message, animated reactions, and the like.

In one embodiment, a first user of a location-based application obtains (e.g., captures or records) media content at a geographic location and submits it to a server to be attached to the geographic location. The server receives the media content along with an identifier of the first user, such as a user ID or device ID, and an indication of the geographic location (e.g., GPS coordinates). The server stores the media content in conjunction with the identifier of the first user and the indication of the geographic location. At a later time, a second user is in the vicinity of the geographic location (e.g., within a threshold distance) and is notified of the media content via a client device. The second user may experience the media content and “wave” to the first user. Once communication has been initiated in this way, the first user may be notified and given an opportunity to acknowledge or ignore the wave. If the first user acknowledges the wave, the first and second users may then be able to send messages to each other using a communication channel within the application. This communication channel may remain open indefinitely (e.g., until one of the users terminates it), until a threshold amount of time has passed since the wave and/or the last communication between the users, or until some other condition is met (e.g., the second user leaves the vicinity of the geographic location).

In some embodiments, the creator or viewer of a video or photograph of a geographic location may select an object depicted in the video or photograph to create a 2D or 3D virtual object representing the depicted object. This virtual object may be held by the user (e.g., in a virtual bag) or dropped at the same or a different geographic location where it may be viewed and interacted with by other users in an augmented reality environment. For example, at a ramen restaurant, a user may record a video of their bowl of ramen and then select the bowl in the video to generate a virtual bowl of ramen which the user may leave for other players to find at the restaurant, keep for themselves as a souvenir to view later, or give to other users as a gift, etc.

### BRIEF DESCRIPTION OF THE DRAWINGS

FIG. 1 depicts a representation of a virtual world having a geography that parallels the real world, according to one embodiment.

FIG. 2 depicts an exemplary game interface of a parallel reality game, according to one embodiment.

FIG. 3 is a block diagram of a networked computing environment suitable for providing a location-based application with asynchronous experiences, according to one embodiment.

FIG. 4 is a block diagram of the asynchronous experience module shown in FIG. 3, according to one embodiment.

FIG. 5 is a flowchart of a process for providing an asynchronous shared virtual experience, according to one embodiment.

FIG. 6 is a flowchart of a process for creating a three-dimension augmented reality object from a real-world object, according to one embodiment.

FIG. 7A is an example interface illustrating an item of media content shared asynchronously between users of the location-based application, according to one embodiment.

FIG. 7B is an example interface illustrating a map view with indications of media content captured by users of the location-based application, according to one embodiment.

FIG. 7C illustrates a plurality of virtual representations of a real-world object depicted in an item of media content, according to one embodiment.

FIG. 8 illustrates an example computer system suitable for use in the networked computing environment of FIG. 3, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations in which providing location-based, asynchronous experiences is desirable. In addition, the inherent flexibility of computer-based systems allows for a great variety of possible configurations, combinations, and divisions of tasks and functionality between and among the components of the system.

### Example Location-Based Parallel Reality Game

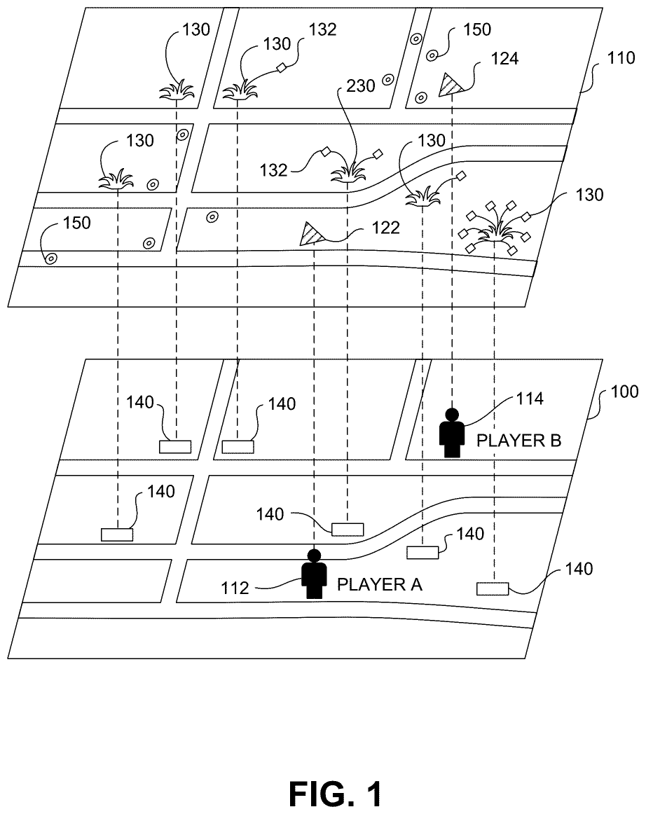

FIG. 1 is a conceptual diagram of a virtual world 110 that parallels the real world 100. The virtual world 110 can act as a space for users to share experiences and make recommendations, serve as a game board for a location-based game, or provide any other function where virtual content is attached to real world geographic locations. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A user's position in the virtual world 110 corresponds to the user's position in the real world 100. For instance, player A located at position 112 in the real world 100 has a corresponding position 122 in the virtual world 110. Similarly, player B located at position 114 in the real world 100 has a corresponding position 124 in the virtual world 110. As the users move about in a range of geographic coordinates in the real world 100, the users also move about in the range of coordinates defining the virtual space in the virtual world 110. In particular, a positioning system (e.g., a GPS system, a localization system, or both) associated with a mobile computing device carried by the user can be used to track a user's position as the user navigates the range of geographic coordinates in the real world 100. Data associated with the user's position in the real world 100 is used to update the user's position in the corresponding range of coordinates defining the virtual space in the virtual world 110. In this manner, users can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based application can include objectives requiring users to travel to or interact with various virtual elements or virtual objects scattered at various virtual locations in the virtual world 110. A user can travel to these virtual locations by traveling to the corresponding location of the virtual elements or objects in the real world 100. For instance, a positioning system can track the position of the user such that as the user navigates the real world 100, the player also navigates the parallel virtual world 110. The user can then interact with various virtual elements and objects at the specific location to achieve or perform one or more objectives.

For example, in a parallel-reality game, a game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. Similarly, in a location-based social application, users may attach media content to virtual elements 130 that correspond to real-world locations, such as restaurants, museums, clubs, stores, sporting venues, and theaters, etc. The media content may describe the attaching user's experience at the location, such as being a video of the location captured by the user while physically present at the location.

Game objectives may require that players use one or more virtual items that are collected by the players in the location-based game. For instance, the players may travel the virtual world 110 seeking virtual items 132 (e.g. weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the application server seeks to ensure players are indeed physically present and not spoofing their locations.

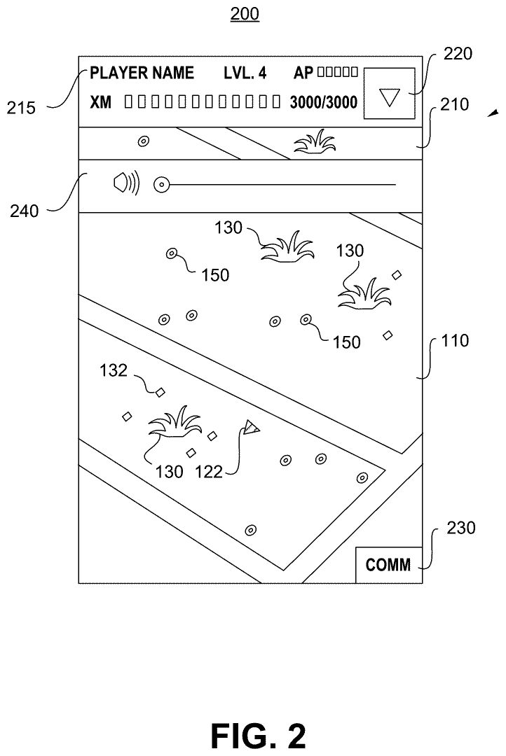

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device 110 around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Location-Based Application System

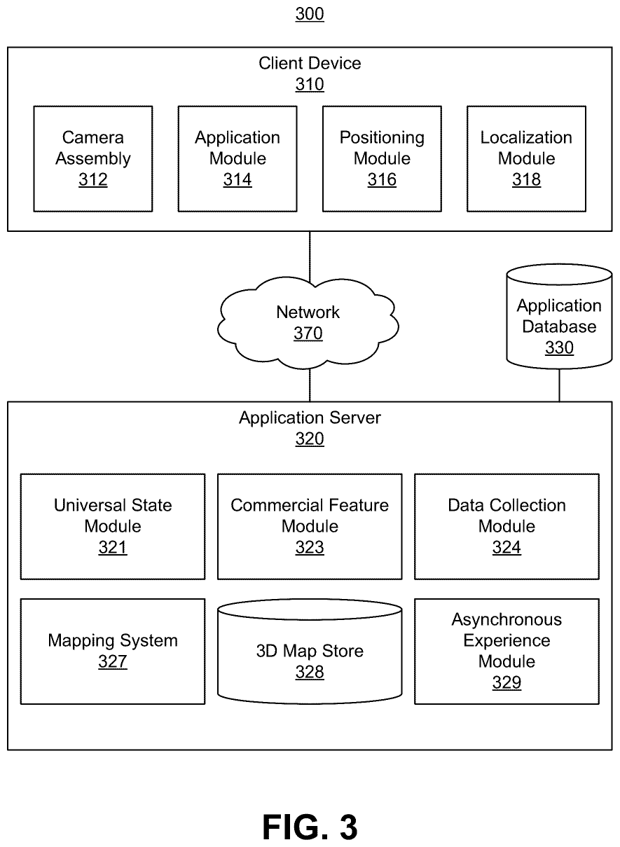

FIG. 3 illustrates one embodiment of a networked computing environment 300. The networked computing environment 300 uses a client-server architecture, where an application server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the application server 320 over the network 370. Furthermore, the networked computing environment 300 may contain different or additional elements and functionality may be distributed between the client device 310 and the application server 320 in different manners than described below.

The networked computing environment 300 provides for the interaction of users in a virtual world having a geography that parallels the real world. In particular, a geographic area in the real world can be linked or mapped directly to a corresponding area in the virtual world. A user can move about in the virtual world by moving to various geographic locations in the real world. For instance, a user's position in the real world can be tracked and used to update the player's position in the virtual world. Typically, the user's position in the real world is determined by finding the location of a client device 310 through which the user is interacting with the virtual world and assuming that the user is at the same (or approximately the same) location. For example, in various embodiments, the user may interact with a virtual element if the user's location in the real world is within a threshold distance (e.g., ten meters, twenty meters, etc.) of the real-world location that corresponds to the virtual location of the virtual element in the virtual world. For convenience, various embodiments are described with reference to “the user's location” but one of skill in the art will appreciate that such references may refer to the location of the user's client device 310.

A client device 310 can be any portable computing device capable for use by a user to interface with the application server 320. For instance, a client device 310 is preferably a portable wireless device that can be carried by a user, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the application server 320 to provide sensory data of a physical environment. In one embodiment, the client device 310 includes a camera assembly 312, an application module 314, positioning module 316, and localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 110 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g. temperature, brightness of environment, air pressure, location, pose etc.) or capture data (e.g. exposure length, shutter speed, focal length, capture time, etc.).

The application module 314 provides a user with an interface to access location-based functionality. The application server 320 transmits application data over the network 370 to the client device 310 for use by the application module 314 to provide a local version of the application to a user at locations remote from the application server. In one embodiment, the application module 314 presents a user interface on a display of the client device 310 that depicts a virtual world (e.g. renders imagery of the virtual world) and allows a user to interact with the virtual world to perform various activities. In some embodiments, the application module 314 presents images of the real world (e.g., captured by the camera assembly 312) augmented with virtual elements from the location-based application. For example, the user may see markers indicating media content attached to geographic locations (e.g., thumbnails or a “media available” icon) by other users and/or virtual objects left by other users at the geographic location.

In some embodiments, the application module 314 may generate or adjust virtual content according to other information received from other components of the client device 310. For example, the application module 314 may adjust a virtual object to be displayed on the user interface according to a depth map of the scene captured in the image data such that the virtual object appears to be sitting on a table, attached to a wall, or partially behind a plant, etc. The application module 314 may also control various other outputs to allow a user to interact with the location-based application without requiring the user to view a display screen. For instance, the application module 314 can control various audio, vibratory, or other notifications to notify the user of available media content in their vicinity without looking at the display screen.

The positioning module 316 can be any device or circuitry for determining the position of the client device 310. For example, the positioning module 316 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the user moves around with the client device 310 in the real world, the positioning module 316 tracks the position of the user and provides the user position information to the application module 314. The application module 314 updates the user position in the virtual world based on the actual position of the user in the real world. Thus, a user can interact with the virtual world simply by carrying or transporting the client device 310 in the real world. In particular, the location of the user in the virtual world can correspond to the location of the user in the real world. The application module 314 can provide user position information to the application server 320 over the network 370. In response, the application server 320 may enact various techniques to verify the location of the client device 310 to prevent users from spoofing their locations (e.g., to cheat in a game or access location-based media that would otherwise be unavailable to them). It should be understood that location information associated with a user is used only if permission is granted after the user has been notified that location information of the user is to be accessed and how the location information is to be utilized in the context of the location-based application (e.g. to update user position in the virtual world). In addition, any location information associated with users is stored and maintained in a manner to protect user privacy.

The localization module 318 receives the location determined for the client device 310 by the positioning module 316 and refines it by determining a pose of one or more cameras of the camera assembly 312. In one embodiment, the localization module 318 uses the location generated by the positioning module 316 to select a 3D map of the environment surrounding the client device 310. The localization module 318 may obtain the 3D map from local storage or from the application server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dad reckoning based on sensor readings, periodic re-localization, or a combination of both. Having an accurate pose for the client device 310 may enable the application module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The application server 320 includes one or more computing devices that provide location-based functionality to the client device 310. The application server 320 can include or be in communication with an application database 330. The application database 330 stores application data used in the location-based application to be served or provided to the client device 320 over the network 370.

The application data stored in the application database 330 can include: (1) data associated with the virtual world (e.g. imagery data used to render the virtual world on a display device, geographic coordinates of locations in the virtual world, etc.); (2) data associated with users of the location-based application (e.g. user profiles including user information, user experience level, user currency, current user positions in the virtual world/real world, user preferences, user grouping information, etc.); (3) data associated with objectives (e.g. data associated with current objectives, status of objectives, past objectives, future objectives, desired objectives, etc.); (4) data associated with virtual elements in the virtual world (e.g. positions of virtual elements, types of virtual elements, objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) application status (e.g. current number of users, current status of objectives, leaderboards for games and other gamified experiences, etc.); (7) data associated with user actions/input (e.g. current user positions, past user positions, user input, user queries, user communications, etc.); or (8) any other data used, related to, or obtained during implementation of the location-based application. The application data stored in the application database 330 can be populated either offline or in real time by system administrators or by data received from users of the system 300, such as from a client device 310 over the network 370.

In one embodiment, the application server 320 is configured to receive requests for application data from a client device 310 (for instance via remote procedure calls (RPCs)) and to respond to those requests via the network 370. The application server 320 can encode application data in one or more data files and provide the data files to the client device 310. In addition, the application server 320 can be configured to receive application data (e.g., user positions, user actions, user input, submitted media content etc.) from a client device 310 via the network 370. The client device 310 can be configured to periodically send user input and other updates to the application server 320, which the application server uses to update application data in the application database 330 to reflect any and all changed conditions for the application.

In the embodiment shown in FIG. 3, the application server 320 includes a universal state module 322, a commercial feature module 323, a data collection module 324, a mapping system 327, a 3D map 328, and an asynchronous experience module 329. As mentioned above, the application server 320 interacts with an application database 330 that may be part of the application server or accessed remotely (e.g., the application database 330 may be a distributed database accessed via the network 370). In other embodiments, the application server 320 contains different or additional elements. In addition, the functions may be distributed among the elements in a different manner than described.

The universal state module 322 hosts an instance of the location-based application for a set of users (e.g., all users of the location-based application) and acts as the authoritative source for the current status of the application for the set of users. As the host, the universal state module 322 generates application content for presentation to users (e.g., via their respective client devices 310). The universal state module 322 may access the application database 330 to retrieve or store application data when hosting the location-based application. The universal state module 322 may also receive application data from client devices 310 (e.g., depth information, user input, user position, user actions, landmark information, media content, etc.) and incorporates the application data received into the overall location-based application for the entire set of users of the application. The universal state module 322 can also manage the delivery of application data to the client device 310 over the network 370. In some embodiments, the universal state module 322 also governs security aspects of the interaction of the client device 310 with the location-based application, such as securing connections between the client device and the application server 320, establishing connections between various client devices, or verifying the location of the various client devices 310 to prevent users from spoofing their location.

The commercial feature module 323 can be separate from or a part of the universal state module 322. The commercial feature module 323 can manage the inclusion of various features within the location-based application that are linked with a commercial activity in the real world. For instance, the commercial feature module 323 can receive requests from external systems such as sponsors/advertisers, businesses, or other entities over the network 370 to include features linked with commercial activity in the real world. The commercial feature module 323 can then arrange for the inclusion of these features in the location-based application on confirming the linked commercial activity has occurred. For example, if a business pays the provider of the location-based application an agreed upon amount, a virtual object identifying the business may appear in the application at a virtual location corresponding to a real-world location of the business (e.g., a store or restaurant).

The data collection module 324 can be separate from or a part of the universal state module 322. The data collection module 324 can manage the inclusion of various features within the application that are linked with a data collection activity in the real world. For instance, the data collection module 324 can modify application data stored in the application database 330 to include features linked with data collection activity in the parallel reality game, such as users submitting media content to be attached to points of interest that correspond to features in the real-world locations. The data collection module 324 can also analyze data collected by users pursuant to the data collection activity and provide the data for access by various platforms.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or other properties (e.g., traversable by virtual characters, suitable for certain actions, such as pinning media content to corresponding surfaces, etc.). In one embodiment, the mapping system 327 stores the 3D map along with any semantic/contextual information in the 3D map store 328. The 3D map may be stored in the 3D map store 328 in conjunction with location information (e.g., GPS coordinates of the center of the 3D map, a ringfence defining the extent of the 3D map, or the like). Thus, the application server 320 can provide the 3D map to client devices 310 that provide location data indicating they are within or near the geographic area covered by the 3D map.

The asynchronous experience module 329 enables users to generate and attach media content to geographic locations to be experienced by other users in proximity to the geographic locations. For example, in one embodiment, a first user of a location-based application captures or records media content depicting a real-world location on a client device 310 and submits the to the application server 320 along with an indication of the geographic location and an identifier of the first user. The application server 320 stores the received media content in conjunction with the identifier of the first user and the indication of the geographic location. At a later time, a second user in the vicinity of the geographic location is notified of the media content via the location-based application on a client device 310 of the second user and may “wave” or otherwise initiate an interaction with the first user.

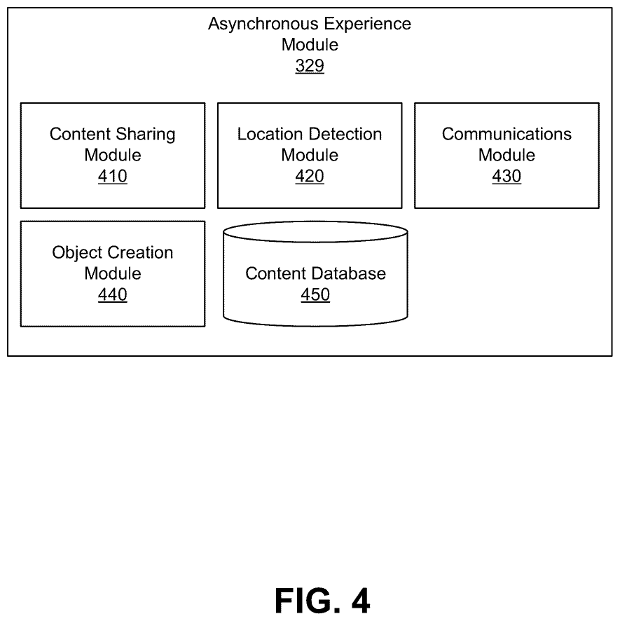

In some embodiments, the asynchronous experience module 329 enables a first user to select an object depicted in a photo or video to create a 2D or 3D virtual object representing the real-world object. The virtual object may be stored for later viewing or use by the first user, placed in an augmented reality space where the first user or other users may view and interact with it, or gifted to one or more other users. The functionality of the asynchronous experience module 329 is described in more detail below with respect to FIGS. 4-7.

The network 370 can be any type of communications network, such as a local area network (e.g., an intranet), wide area network (e.g., the internet), or some combination thereof. The network can also include a direct connection between a client device 310 and the application server 320. In general, communication between the application server 320 and a client device 310 can be carried via a network interface using any type of wired or wireless connection, using a variety of communication protocols (e.g. TCP/IP, HTTP, SMTP, FTP), encodings or formats (e.g. HTML, XML, JSON), or protection schemes (e.g. VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Asynchronous Experience Module

FIG. 4 illustrates one embodiment of the asynchronous experience module 329 of FIG. 3. In the displayed embodiment, the asynchronous experience module 329 includes a content sharing module 410, a location detection module 420, a communications module 430, an object creation module 440, and a content database 450. In various embodiments, the asynchronous experience module 329 may include different or additional components, and the functionality may be distributed between the client device 310 and the server 320 and among the elements of the asynchronous experience module 329 in different manners than described below.

The content sharing module 410 receives media content from a first user of a location-based application and stores the received content for later viewing by one or more other users of the application. In one embodiment, the content sharing module 410 receives media content, such as a photo or video, depicting a real-world geographic location along with an indication of the location and an identifier of a first user from a client device 310. The indication of the location may be an identifier of a virtual element (e.g., a point of interest) in the virtual world to which the user requested attachment of the media content, GPS coordinates, or any other indicator of the real-world location depicted by the media content. The identifier of the user may be a user ID, a device ID, or any other information that identifies the user who submitted the media content.

The media content may optionally include a caption or message supplied by the first user. For example, where the media content is a photo of a plate of tacos captured at a restaurant, the caption might include the name of the restaurant and the user's review (“An Austin must. These tacos aren't messing around!”). As another example, where the media content is a video of the first user navigating a park, the caption might recommend to other users that they explore a certain path or suggest a spot for relaxing in the shade.

The caption or message supplied by the first user may be viewable by any other user of the location-based application who subsequently visits the depicted geographic location or may be directed to one or more specific users. For example, the first user may attach, to a geographic location, a personal message including text, one or more images, audio, or video content, specify one or more other users who have access to the message (e.g., by providing a user ID or selecting them from a friends list), and generate a request to attach the message to the user's current (or a previously visited) location. To give a specific example, a first user eats at a restaurant and thinks the vegetable jalfrezi is amazing. They take a photograph of their food, type out a message explain how great the vegetable jalfrezi is, and attach it to the geographic location of the restaurant, identifying a second user who also loves curry as the recipient.

Additionally, in some embodiments, the first user may specify one or more content display parameters for the media content, such a limitation on which other user(s) may view the content or an indication that the content may be accessed by any other user of the location-based application, an expiration date or other time-based restriction for viewing the content, a limitation on which user(s) can initiate a communication with the first user based on the content or a type of communication that may be initiated, and the like. For example, the first user may limit who may “wave” or otherwise communicate with the first user to friends only, or friends and their friends, or other subsets of users (e.g., anyone the user has not blocked).

The content sharing module 410 stores the media content, the indication of the location, the identifier of the first user, the optional caption or message, and the optional content display parameters in the content database 450.

The location detection module 420 receives current locations of client devices 310 and queries the content database 450 to identify media content attached to geographic locations within a threshold location of a client device, within the same S2 cell of a specified level (e.g., L14-L17) of the current location, or within a ringfenced area that also encompasses the current location, etc. The location detection module 420 may provide some or all of the media content proximate to the current location of a client device 310 to that client device 310 for presentation to a user. For example, indications of videos captured by other users and attached to a geographic location may be presented by a client device 310 near that geographic location (e.g., as icons displayed in an AR headset or overlaid on a video feed captured by a camera of the client device).

In some embodiment, the display of media content to users of client devices 310 is subject to any applicable content display parameters supplied by the first user, as discussed above. The location detection module 420 queries the content database 450 for content display parameters associated with media content attached to the geographic location and filters out media content for which the content display parameters are not met. For example, in embodiments where the first user has limited viewing of the media content to friends only, the media content does not appear on the client devices 310 of users who are not friends with the first user on the location-based application.

Conversely, the location detection module 420 affirmatively selects media content for display to one or more viewing users if the content display parameters are met. For example, if the first user has attached a personal message to a second user at a geographic location and the location detection module 420 determines that the second user is located at the geographic location or within a geographic proximity to the location to which the message is attached, the location detection module 420 provides the personal message, including any text, images, audio content, or video content, to the client device 310 of the second user. Continuing the “vegetable jalfrezi” example above, if the second user goes to the restaurant, the second user receives, via the location detection module 420, a notification that the first user has left them a message and can view the recommendation to try the vegetable jalfrezi. Thus, the two users have a shared, asynchronous experience.

If a third user has traveled with the second user to the geographic location but the content display parameters indicate that the message is viewable only to the second user, the location detection module 420 provides the message for display on the client device 310 of the second user but not on the client device 310 of the third user, even if the second user and third user are both at the geographic location. That is, the third user will not receive the recommendation for the vegetable jalfrezi from the first user. If, however, the content display parameters instead indicate that the media content is viewable by any users of the location-based application, the location detection module 420 will also notify the third user of the first user's recommendation upon detecting that the third user is at the geographic location (e.g., the restaurant).

Users viewing the media content shared by other users of the location-based application may view, in addition to the media content itself and any associated caption or message, an indication of the user who created the content (e.g., the submitting user's name or avatar), the date the content was created or an amount of time that has elapsed since creation (e.g., “Yesterday,” “1 month ago”), a name or other identifier of the associated geographic location (e.g. a restaurant name, a park name, a neighborhood), and the like. In various embodiments, viewing users may react to the content item (e.g., to indicate their approval or disapproval), comment on or view previous comments associated with the media content, pin the media content to save it for later viewing by the user, or share the media content with one or more other users, subject to any content display parameters provided by the submitting user.

In some embodiments, the location detection module 420 provides a map with visual indications of media content attached to locations. The location-based application may provide search and filtering options for a user to identify media content of interest and view that media content. For example, a user in a neighborhood they are not familiar with might identify videos submitted by their friends eating at various restaurants in the area and view them to make a decision about where to eat. Viewing videos submitted by other users provides a much more direct way to evaluate potential restaurant options than conventional written reviews.

The client device 310 may display an item of media content in response to a user tapping on or otherwise selecting the indication of that media content. In one embodiment, the communications module 430 provides for display on the client device 110 a user interface through which the viewing user can “wave” to the user who submitted the media content. If the viewing user elects to wave to the submitting user, the client device 310 sends a wave request to the communications module 430. The communications module 430 identifies a second client device 310 associated with the submitting user (e.g., by querying the content database 450 for the submitting user or by looking up a client device identifier stored in conjunction with the media content) and send a wave notification to the second client device 310. The wave notification includes an identifier of the viewing user and causes the second device 310 to present a notification to the submitting user that the viewing user has waved at them. As discussed above, a viewing user's ability to communicate with the submitting user via wave or other communication may be limited or restricted based on content parameters provided by the submitting user.

In some embodiments, the submitting user may ignore a wave from the viewing user, in which case, nothing further happens, or “wave back” to instantiate a communication channel between the client devices 310 of the viewing and submitting users. In this case, the viewing and submitting users may then exchange messages even if they previously could not (e.g., without knowing each other or having any other identifying information about each other). The messages may be limited to a preselected set of default messages (e.g., a set of default text messages and reaction icons) or may be more open ended, allowing the inclusion of one or more of: typed text, photos, videos, or audio recordings, etc. In some implementations, the communication channel may initially be limited to pre-defined messages but, if both users agree, the communication channel may be opened up to allow user-provided text, photos, videos, or audio recordings, etc.

The object creation module 440 enables users to generate 2D or 3D virtual representations of real-world objects depicted in photos or videos. In one embodiment, a user views a photo or video and selects an object that is depicted. Alternatively, the user initiates the camera assembly 312 on the client device 310 and selects a real-world object within the scene of the environment surrounding the client device 110. The object creation module 440 generates a virtual representation of the selected object. In one embodiment, the object creation module 440 uses the photo or video to generate a 2D or 3D model (e.g., a mesh) of the depicted object. Semantic segmentation may be used to identify properties of the object (or parts of the object) such as the soup in a bowl being liquid while the bowl itself is solid, or a beachball being bouncy while a beanbag is not, etc. In some embodiments, the object creation module 440 may direct the user to capture additional photos or video of the object to build a more accurate virtual model of the object. For example, the object creation module 440 may cause the application on the user's client device 310 to display instructions to record a video while moving the camera around the object. The application may direct the user to move the camera in certain directions and rotate it to certain orientations to capture specific information (e.g., a side of the object not already seen in earlier photos/video).

Regardless of the precise approach used, once the 2D or 3D model is generated, the object creation module 440 may use the model to instantiate a virtual object representing the selected real-world object. The virtual object may be a realistic virtual depiction of the real-world object or the object creation module 440 may apply one or more styles to the virtual object, such as generating a cartoonish representation of the object, a black and white version of the object, a highly stylized or less stylized version of the object, a version in which the object colors are inverted or changed, etc.

In one embodiment, the objection creation module 440 provides for display on the client device 310 multiple versions of the virtual object and allows the user to select a version for storage or use. For example, the user might select a beachball depicted in a video, and the object creation module 440 might generate multiple virtual objects that are different 3D renderings of the beachball. Depending on the embodiment, the user may then do one or more of: selecting one or more of the virtual objects to view later as a souvenir of their time at the geographic location, place one or more of the virtual objects in an augmented reality space and interact with it (e.g., throw the beachball around the room by selecting it within an application on their client device 310), gift one or more of the virtual objects to another user, etc. In some instances, the user may initially store a virtual object and later place it in an augmented reality space (e.g., at a different real-world location), interact with it for a time, and then store it again (e.g., to later place in a different augmented reality environment at a different real-world location). Furthermore, when ta virtual object is placed in an augmented reality environment, it may be seen and interacted with by other users in the same geographic location, subject to any content display parameters provided by the creating user. For example, a group of friends may throw around” a virtual beachball at home to remember the time they threw around the real beachball the virtual object is modelled on at a beach party.

### Example Methods and Interfaces

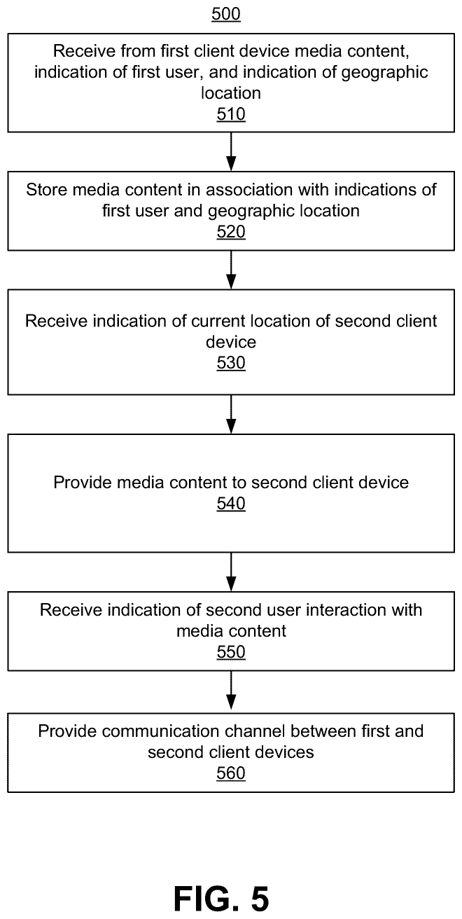

FIG. 5 is a flowchart describing an example method 500 of providing an asynchronous shared virtual experience, according to one embodiment. The steps of FIG. 5 are illustrated from the perspective of the asynchronous experience module 329 performing the method 500. However, some or all of the steps may be performed by other entities or components. In addition, some embodiments may perform the steps in parallel, perform the steps in different orders, or perform different steps.

In the embodiment shown, the method 500 begins with the content sharing module 410 receiving 510 content from a client device 310 of a first user of a location-based application. In one embodiment, the content includes an item of media content (such as a photo or video), an indication of a first user associated with the first client device 310 (such as a user or player ID), and an indication of a geographic location (such as geographic coordinates of a geographic location at which the media content was captured). The received content may also optionally include a caption or message supplied by the first user, such as a description of the media content or a message directed to one or more other users of the location-based application, and one or more content display parameters that limit display of the media content. For example, a content display parameter might provide an expiration date after which the media content should not be displayed, limit display of the media content to one or more specific users or user groups (e.g., friends of the user or friends of friends), allow for display of the media content to any user of the location-based application, or limit whether and how a viewing user may communicate with the first user (e.g., via a “wave”).

The content sharing module 410 stores 520 the received media content in association with the indications of the first user and the geographic location (e.g., in the content database 450). Where the first user has provided one or more content display parameters, the parameters are also stored in conjunction with the media content.

The location detection module 420 receives 530 an indication of a current location of a second client device 310 associated with a second user of the location-based application. For example, the indication may be received at a later time when the second user is in the vicinity (e.g., within a threshold distance) of the geographic location associated with the media content.

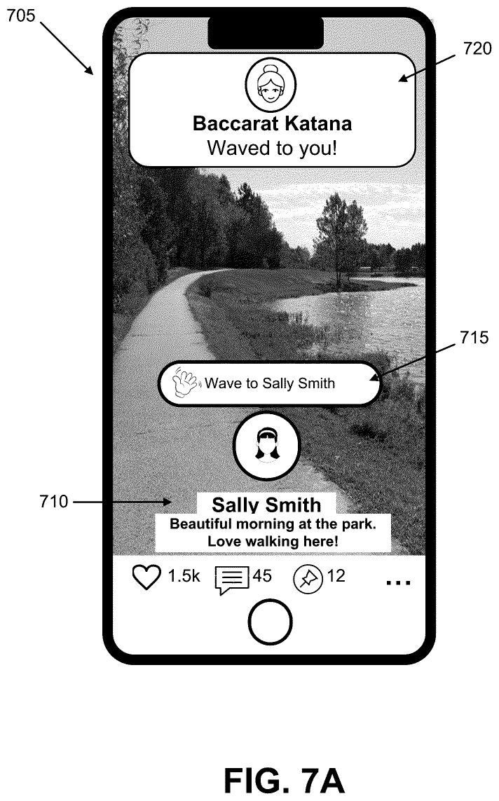

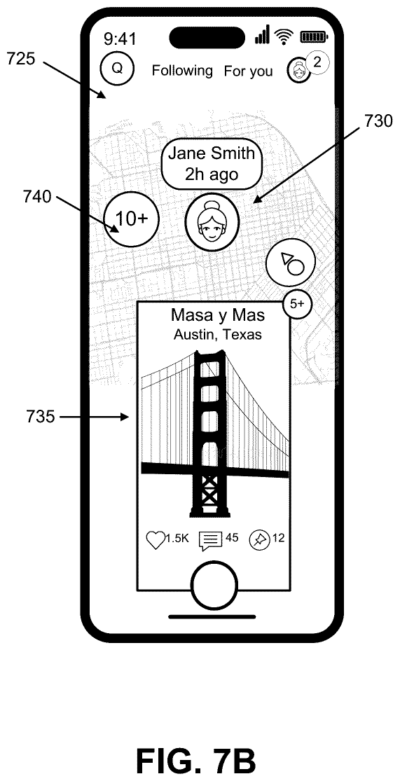

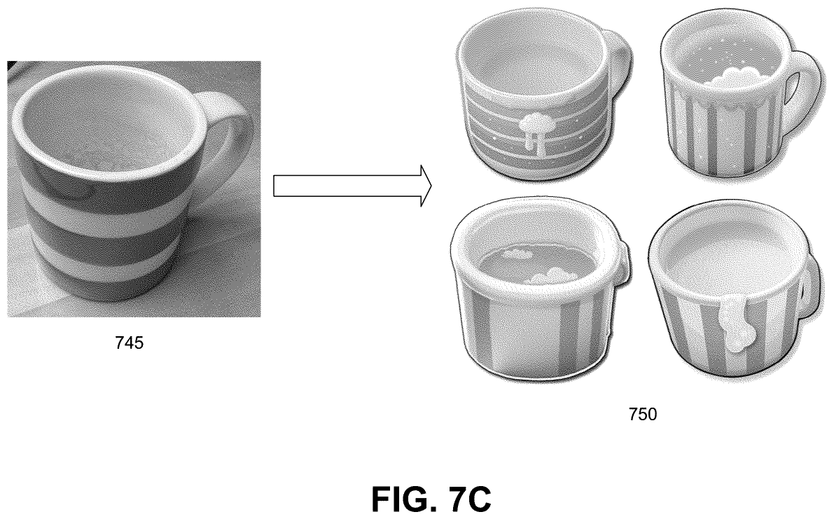

If the content display parameters permit the second user to experience the media content, the location detection module 420 provides 540 the media content for display to the second client device 310. If the media content is associated with a message or caption directed specifically to the second user or to any viewing users of the media content, the message or caption is provided for display with the media content. For example, where the media content is a photograph captured inside of a coffee shop, an associated caption might recommend a specific drink to the viewing user. In another example, as shown in the interface 705 of FIG. 7A, the second user may be located at a park from which another user of the location-based application previously captured and posted content. Here, interface elements 710 illustrate that user “Sally Smith” previously visited the same park and shared a photo of a walking trail along with the caption: “Beautiful morning at the park. Love walking here!” In this way, the second user and user Sally Smith are having a shared, asynchronous virtual experience.

In another embodiment, the media content is provided for display to a viewing user in a map format with indications of media content attached to locations within the vicinity (e.g., a threshold distance) of the viewing user. That is, while the embodiment discussed above contemplates display of media content associated with a geographic location when the second user is at or near that location (e.g., outside or inside the coffee shop in the previous example), in another embodiment, the viewing user may use a map view to see indications of media content associated with geographic locations within a larger vicinity (e.g., within a second threshold distance of the second client device 310). For example, a map view may represent the city or neighborhood in which the second user is located and may include indications of media content associated with discrete geographic locations within that city or neighborhood. The second user can therefore view multiple indications of media content at the same time and can interact with any of the displayed indications (e.g., by tapping on one) to view the media content itself and any associated captions or messages.

For example, FIG. 7B depicts an example map interface 725 of the location-based application displayed on a client device 310 of a viewing user. The displayed interface 725 depicts a map of the area surrounding the viewing user, such as the city in which the viewing user is located and includes indications of media content captured by other users of the location-based application at real-world locations within the confines of the map. For example, the interface 725 includes an indication 730 of media content captured by user Jane Smith two hours ago. Responsive to the viewing user hovering over, selecting (e.g., by tapping) or otherwise interacting with the indication 730, the captured media content is provided for display on the client device 310. For example, the interface 725 includes a frame 735 depicting a photograph or a video of a bridge along with a location tag indicating where the image was capture (Masa y Mas in Austin, Texas) and indications of user reactions to the media content, such as a number of times other users of the location-based application liked, commented on, or pinned the media content. In various embodiments, the media content may also include a caption or message, such as a review of the tacos at Masa y Mas or a recommendation about where to sit for the best view.

The interface 725 also includes an icon 740 indicating other items of media content captured at real-world geographic locations within the displayed area. For example, responsive to the viewing user zooming in on the interface 725 or tapping the icon 740, indications of other media content provided by other users of the location-based application are provided for display on the interface 725. In this way, the viewing user can quickly and easily explore their surroundings based on images, videos, recommendations, and reviews from other users of the location-based application without having to travel to each discrete location at which the media content items were captured.

Returning now to FIG. 5, regardless of whether the media content is provided for display while the second user is located at the geographic location associated with the media content or views the media content via a map interface, the second user may interact with the media content to initiate a communication with the first user. When the communications module 430 receives 550 an indication of a second user interaction with the media content, the communications module 430 provides 560 a communication channel between the first and second client devices 310, subject to any content display parameters provided by the first user. For example, the communications module 430 provides for display on the second client device 310 a user interface element, the selection of which allows the second user to “wave” to the first user. If the second user elects to wave to the first user, the client device 310 of the second user sends a wave request to the communications module 430, which identifies a client device 310 of the first user using, e.g., the user indication information stored in association with the media content in the content database 450. A wave notification is transmitted to the first client device 310, notifying the first user that the second user has waved at them. The first user may ignore the wave from the second user or, if the first user elects to “wave back,” the communications module 430 instantiates a communication channel between the first and second client devices 310, allowing the first and second users to exchange messages or otherwise communicate with each other. For example, returning to FIG. 7A, the interface 705 includes element 715 prompting the second user to “Wave to Sally Smith” and element 720 indicating that a third “Baccarat Katana” has waved to the second user (e.g., in response to other content posted by the second user or if the second user and third user are friends on the location-based application).

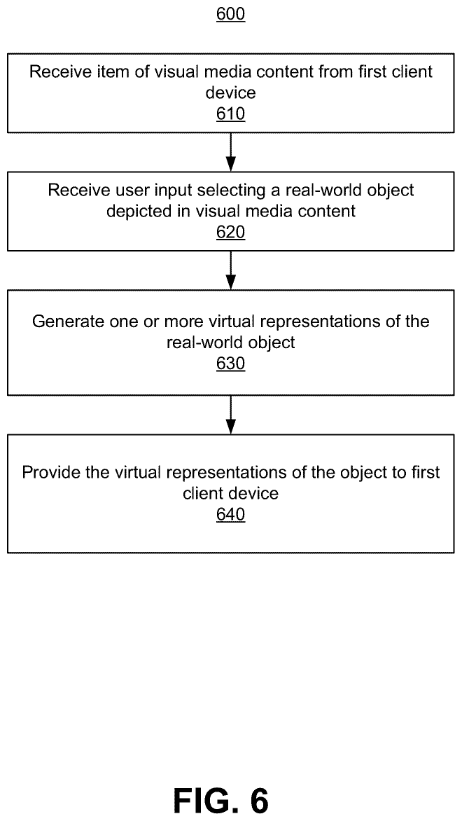

FIG. 6 is a flowchart describing an example method 600 of creating a three-dimension augmented reality object from a real-world object, according to one embodiment. The steps of FIG. 6 are illustrated from the perspective of the asynchronous experience module 329 performing the method 600. However, some or all of the steps may be performed by other entities or components. In addition, some embodiments may perform the steps in parallel, perform the steps in different orders, or perform different steps.

In the embodiment shown, the method 600 begins with the objection creation module 440 on the application server 320 receiving 610 an item of visual media content, such as a photo or video, from a first client device 310 of a first user of the location-based application (e.g., captured by a camera assembly 312 on the client device 310). The media content may depict one or more real-world objects. For example, if the media content is an image of the user's table at a coffee shop, the real-world objects might include a coffee cup, a plate with a pastry on it, a napkin holder, etc.

After receiving the item of visual media content, the object creation module 440 further receives 620 user input selecting a real-world object depicted in the visual media content. For example, the user may tap on or otherwise interact with a portion of the visual media content to indicate a selection of a real-world object, such as the coffee cup in the image of the user's table at the coffee shop.

The object creation module 440 generates 630 one or more virtual objects comprising representations of the selected real-world object, for example, by generating a 2D or 3D model (e.g., a mesh) of the object. In some embodiments, the user may be prompted to capture additional photos or videos of the object to build a more accurate virtual model. For example, the object creation module 440 might instruct the user to record a video while moving the camera assembly 312 of the client device 310 around the coffee cup or to move the camera assembly 312 in certain directions to capture portions of the coffee cup not seen in the initial item of visual media content.

Once the 2D or 3D model of the object is generated, the objection creation module 440 uses the model to instantiate one or more virtual representations of the object (e.g., virtual objects). The virtual objects may be a realistic virtual depiction of the object or may be stylized in a variety of manners. For example, FIG. 7C illustrates a photograph of a coffee cup 745 (i.e., an item of media content depicting a real-world object) and a plurality of virtual objects 750 representing the depicted object. As shown in FIG. 7C, each of the virtual objects 750 depicts the real-world object in a different manner, e.g., by changing the design on the coffee cup, the handle of the cup, or the cup's contents.

At 640, the object creation module 440 provides 640 the one or more virtual objects to the first client device 310. For example, the plurality of virtual objects 750 may be displayed to the first user via the first client device 310 and the user may select one of the virtual objects 750 to store or use in the location-based application. Alternatively, the object creation module 440 may provide only a single virtual object to the first client device 310.

The user may store a generated virtual object to view or use later (e.g., as a souvenir of their time at the geographic location or as part of a collection of different types of virtual objects), may place the virtual object in an augmented reality space and interact with it and allow other users to interact with it, or may gift the visual object to one or more other users of the location-based application.

### Example Computing System

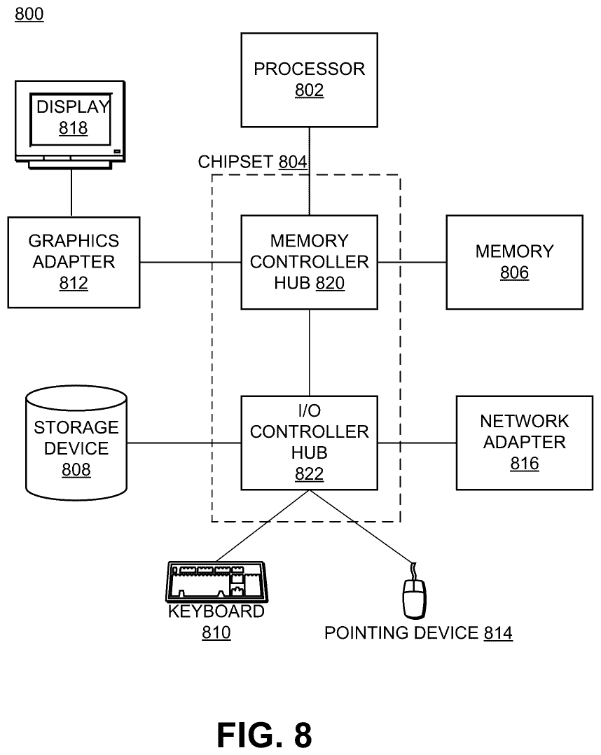

FIG. 8 is a block diagram of an example computer 800 suitable for use as a client device 310 or application server 320. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touch-screen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks, such as network 370.

The types of computers used by the entities of FIG. 8 can vary depending upon the embodiment and the processing power required by the entity. For example, the application server 320 might include multiple blade servers working together to provide the functionality described. Furthermore, the computers can lack some of the components described above, such as keyboards 810, graphics adapters 812, and displays 818.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method comprising:
receiving an item of visual media content from a first client device, the visual media content depicting one or more real-world objects;
receiving user input selecting an object of the one or more real-world objects;
generating one or more virtual representations of the selected object using the visual media content; and
providing at least one virtual representation of the selected object for display at the first client device.

2. The computer-implemented method of claim 1, further comprising:
providing a plurality of virtual representations of the selected object for display at the first client device;
receiving user input comprising a selection of a virtual representation of the plurality of virtual representations; and
providing the selected virtual representation to the first client device.

3. The computer-implemented method of claim 1, further comprising:
receiving user input comprising a selection of one or more other users of a location-based application; and
providing the at least one virtual representation of the selected object for display at a client device of each of the selected one or more users.

4. The computer-implemented method of claim 1, further comprising:
receiving user input comprising an identification of a location in a virtual world paralleling the real world; and
placing the at least one virtual representation of the selected object at the identified location in the virtual world.

5. The computer-implemented method of claim 1, wherein generating the one or more virtual representations of the selected object comprises:
generating a two-dimensional (2D) or three-dimensional (3D) model of the selected object using the visual media content; and
instantiating the one or more virtual representations of the object using the 2D or 3D model.

6. The computer-implemented method of claim 5, further comprising:
instructing a user of the first client device to capture one or more additional photos or videos of the selected object; and
generating the 2D or 3D model using the one or more additional photos or videos.

7. The computer-implemented method of claim 1, wherein the one or more virtual representations of the selected object are stored in association with a location at which the item of visual media content was captured.

8. A computer-implemented method comprising:
receiving, from a first client device, media content, an indication of a first user of a location-based application, and an indication of a geographic location depicted in the media content;
storing the media content in association with the indication of the first user and the indication of the geographic location depicted in the media content;
receiving an indication of a current location of a second client device associated with a second user of the location-based application;
responsive to the current location being proximate to the geographic location, providing the media content to the second client device for presentation to the second user; and
providing, in response to a request from the second client device indicating the second user interacted with the media content, a communication channel between the second client device and the first client device.

9. The computer-implemented method of claim 8, further comprising:
receiving, from the first client device, one or more content display parameters associated with the media content; and
storing the content display parameters in association with the media content, wherein the media content is provided for display to the second client device subject to the one or more content display parameters.

10. The computer-implemented method of claim 9, wherein the one or more content display parameters include one or more of: an identification of one or more other users of the location-based application to whom the media content may be displayed, an indication that the media content may be displayed to any other users of the location-based application, and an expiration date or other time-based restriction for display of the media content.

11. The computer-implemented method of claim 8, further comprising:
receiving, from the first client device, an identification of the second user as a recipient of the media content and a message from the first user to the second user; and
responsive to determining that the second client device is proximate to the geographic location depicted in the media content, providing the media content and the message to the second client device for presentation to the second user.

12. The computer-implemented method of claim 8, further comprising:
providing for display on the second client device a map interface including indications of media content captured at geographic locations within a threshold distance of the second client device; and
responsive to receiving user input comprising a selection of a displayed indication of media content, providing the media content to the second client device for presentation to the second user.

13. The computer-implemented method of claim 8, wherein the second user provides input to initiate a communication with the first user and wherein the communication channel is opened responsive to the first user providing input to acknowledge the communication.

14. The computer-implemented method of claim 8, wherein the communication channel remains open until terminated by the first user or the second user, until a threshold amount of time has passed since a most recent communication between the first user and the second user, or until the second client device is no longer proximate to the geographic location.

15. A computer-implemented method comprising:
receiving, from a first client device of a first user of a location-based application, media content, an indication of a geographic location associated with the media content, and an indication of a second user intended as a recipient of the media content;
storing the media content in association with the first user and the geographic location associated with the media content;
receiving an indication of a current location of a second client device associated with the second user; and
responsive to the current location being proximate to the geographic location, providing the media content to the second client device for presentation to the second user.

16. The computer-implemented method of claim 15, wherein the media content is a message from the first user to the second user.

17. The computer-implemented method of claim 15, further comprising:
receiving, from the first client device, one or more content display parameters associated with the media content; and
storing the content display parameters in association with the media content, wherein the media content is provided for display to the second client device subject to the one or more content display parameters.

18. The computer-implemented method of claim 15, further comprising: providing, in response to a request from the second client device indicating the second user interacted with the media content, a communication channel between the second client device and the first client device.

19. The computer-implemented method of claim 18, wherein the second user provides input to initiate a communication with the first user and wherein the communication channel is opened responsive to the first user providing input to acknowledge the communication.

20. The computer-implemented method of claim 18, wherein the communication channel remains open until terminated by the first user or the second user, until a threshold amount of time has passed since a most recent communication between the first user and the second user, or until the second client device is no longer proximate to the geographic location.
